(19) United States
(12) Patent Application Publication
(10) Pub. No.: US 2015/0100912 A1
(43) Pub. Date: Apr. 9, 2015

(54) PORTABLE ELECTRONIC DEVICE AND METHOD FOR CONTROLLING THE SAME

(71) Applicant: Wistron Corp., New Taipei City (TW)

(72) Inventor: Hung-Cheng CHANG, New Taipei City (TW)

(73) Assignee: Wistron Corp., New Taipei City (TW)

(21) Appl. No.: 14/214,347

(22) Filed: Mar. 14, 2014

(30) Foreign Application Priority Data
Oct. 8, 2013 (TW) 102136283

(51) Int. Cl. G06F 3/0488; G06F 3/0484; G06F 3/0486

(52) U.S. Cl. CPC G06F 3/04886; G06F 3/0486; G06F 3/04842
USPC 715/773

(57) ABSTRACT

Portable electronic device and method for controlling the same are provided. The portable electronic device includes a user interactive touch panel and a controller. The touch panel displays a screen object and a virtual touchpad. When the virtual touchpad is dragged and dropped from a first location to a second location, the touchpad is moved and displayed on the second location accordingly. When contact gestures are implemented on the virtual touchpad, the screen object is manipulated according to the contact gestures.

### CROSS REFERENCE TO RELATED APPLICATIONS

This application claims priority of Taiwan Patent Application Ser. No. 102136283, filed Oct. 10, 2008, entitled Portable Electronic Device and Method for Controlling the Same. The contents of this application are hereby incorporated by reference.

### BACKGROUND OF THE INVENTION

1. Field of the Invention

The present invention relates to a portable electronic device, and in particular, to providing a virtual touchpad (on-screen touchpad) on a touch panel equipped in a portable electronic device.

2. Description of the Related Art

Recently, touch-screen-equipped portable electronic devices, such as tablet computers, are being marketed widely. A user can interact with the portable electronic device through the equipped touch panel.

For handling a tablet computer having a touch panel larger than 7 inches, both hands may be required. For example, one hand is used for holding the tablet computer, and the other hand is used for moving a cursor or other element around the touch panel. Under some circumstances, holding the tablet computer with both hands is more comfortable for the user. Under some circumstances, only one hand is available for handling the tablet computer.

Accordingly, there is a need for a touch-screen-equipped portable electronic device that is easy to handle by both hands or by one hand. More specifically, there is a need for a touch-screen-equipped portable electronic device that provides a moveable virtual touchpad on the touch panel. A user can move the virtual touchpad around the touch panel.

### BRIEF SUMMARY OF THE INVENTION

In an exemplary embodiment, a method for controlling a portable electronic device with a user interactive touch panel is provided. The method includes the following steps: displaying a display screen on the touch panel and displaying a screen object on the display screen; displaying a virtual touchpad (on-screen touchpad) at a first location on the display screen; upon detecting that the virtual touchpad has been dragged and dropped by a real object from the first location to a second location, moving and displaying the virtual touchpad at the second location; and upon detecting a contact gesture implemented by the real object on the display screen, moving and displaying the screen object according to the detected contact gesture.

In the above method, the screen object is a screen cursor. In addition, both the first location and the second location are located at the margin of the display screen. The real object is a user's fingertip.

In the above method, upon detecting the movement of the real object on the display screen, controlling the screen object to move in a direction and distance corresponding to the direction and distance of the detected motion of the real object.

In the above method, upon detecting a single-click operation by the real object on the screen object, selecting a particular item displayed on a location corresponding to the screen object.

In the above method, upon detecting a double-click operation by the real object on the screen object, activating a particular item displayed in a location corresponding to the screen object.

In another exemplary embodiment, a portable electronic device is provided. The portable electronic device includes a user interactive touch panel and a control unit. The user interactive touch panel displays a display screen and receives touch inputs, displays a screen object on the display screen, and displays a virtual touchpad at a first location on the display screen. The control unit, when detecting that the virtual touchpad has been dragged and dropped by a real object from the first location to a second location, moves and displays the virtual touchpad at the second location, and when detecting a contact gesture implemented by the real object on the touch panel, moves and displays the screen object according to the detected contact gesture.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating a portable electronic device according to an embodiment of the invention;

FIG. 2 is a flowchart illustrating the method of setting a location for a virtual touchpad according to an embodiment of the invention;

FIGS. 3A-3D illustrate display screens according to an embodiment of the invention; and

FIG. 4 is a flowchart illustrating the method for manipulating a virtual touchpad according to an embodiment of the invention.

### DETAILED DESCRIPTION OF THE INVENTION

A detailed description is given in the following embodiments with reference to the accompanying drawings.

The following description is of the best-contemplated mode of carrying out the invention. This description is made for the purpose of illustrating the general principles of the invention and should not be taken in a limiting sense. The scope of the invention is best determined by reference to the appended claims.

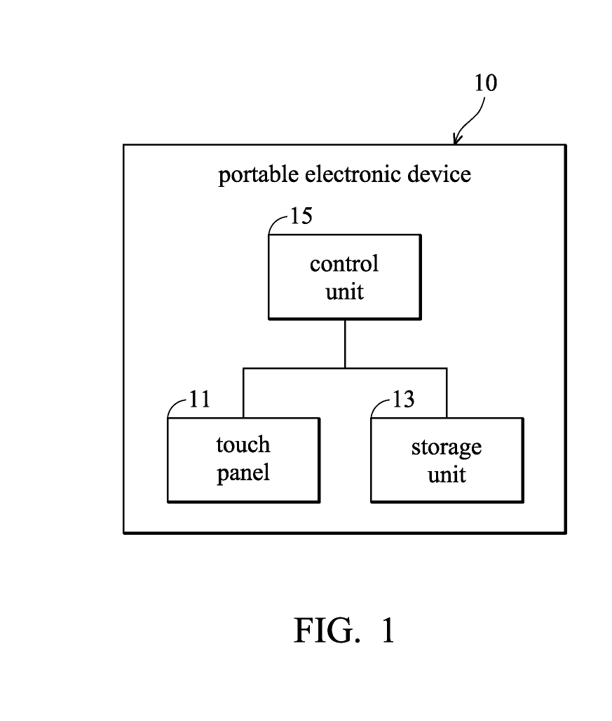

FIG. 1 is a schematic diagram illustrating a portable electronic device according to an embodiment of the invention. According to an embodiment, the portable electronic device 10 can be a tablet computer.

The portable electronic device 10 includes a user interactive touch panel 11, a storage unit 13, and a control unit 15.

The user interactive touch panel 11 has a touch-sensitive surface. The user interactive touch panel 11 can detect contact and movement of an input tool, such as a stylus or fingertip on the touch-sensitive surface. The user interactive touch panel 11 can display related graphics, data, and interfaces. The user interactive touch panel 11 receives inputs corresponding to user manipulation, and transmits the received inputs to the control unit 15 for further processing.

The storage unit 13 stores personal data, settings and software of the portable electronic device 10. The personal data can be various user data or personal files such as an address book, call list, received/sent messages, and internet cookies.

The control unit 15 executes a method of controlling the portable electronic device with a user interactive touch panel of the invention. Related details are discussed later.

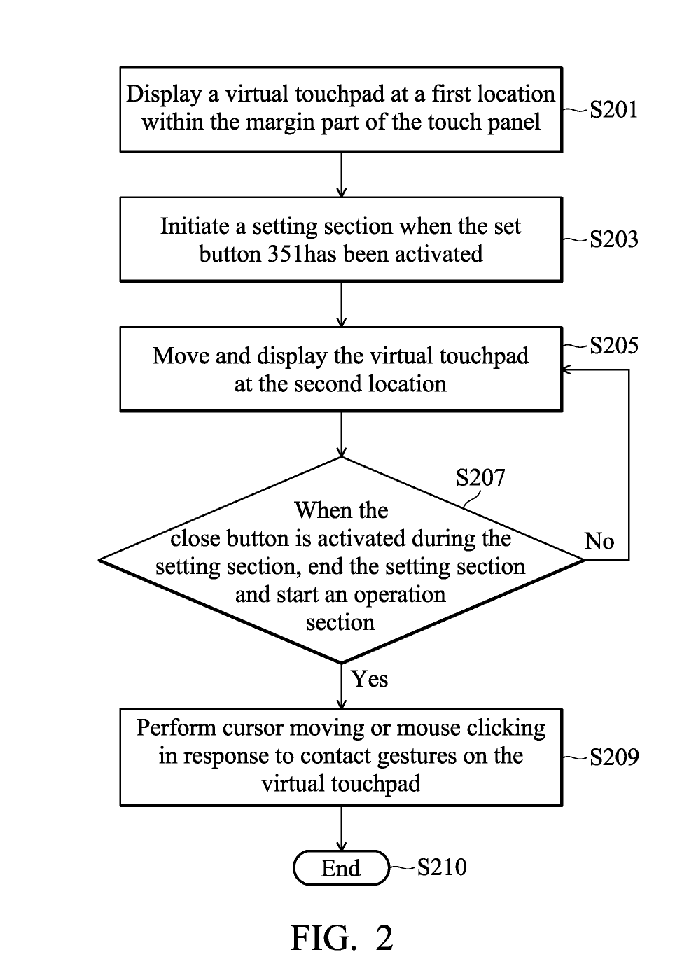

FIG. 2 is a flowchart illustrating the method of setting a location for a virtual touchpad according to an embodiment of the invention. The method of setting a location for a virtual touchpad can be used in a portable electronic device, including, but not limited to, a PDA (Personal Digital Assistant), a smartphone, a tablet computer, or the like. According to an embodiment, the portable electronic device is equipped with a user interactive touch panel (hereinafter referred to as a touch panel).

While the process flow described below includes a number of operations that appear to occur in a specific order, it should be apparent that these processes may include more or fewer operations, which may be executed serially or in parallel (for example, using parallel processors or a multi-threading environment).

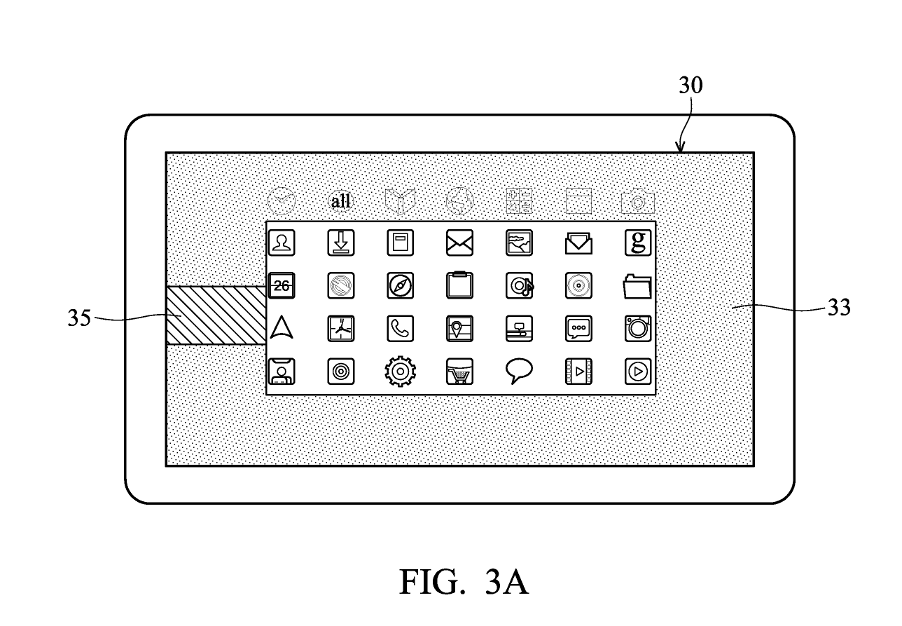

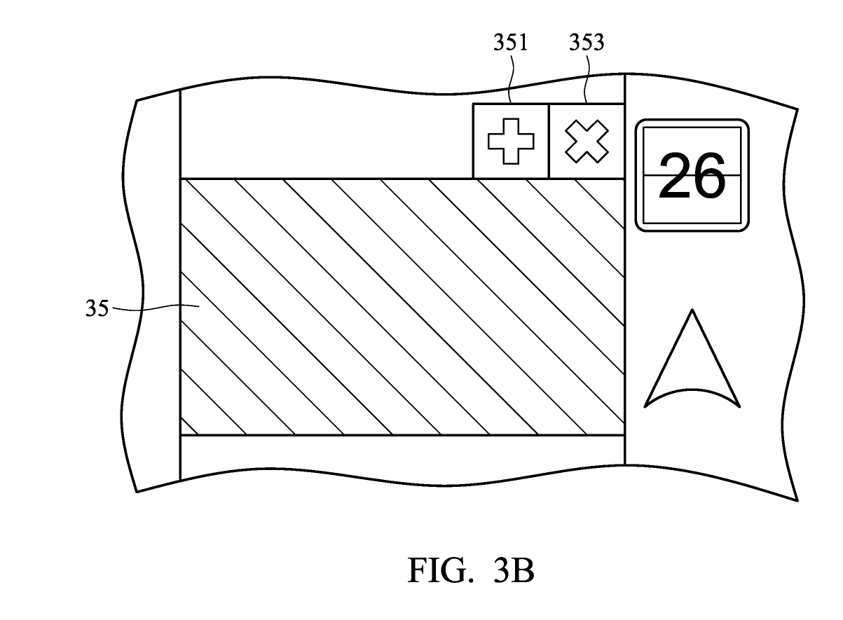

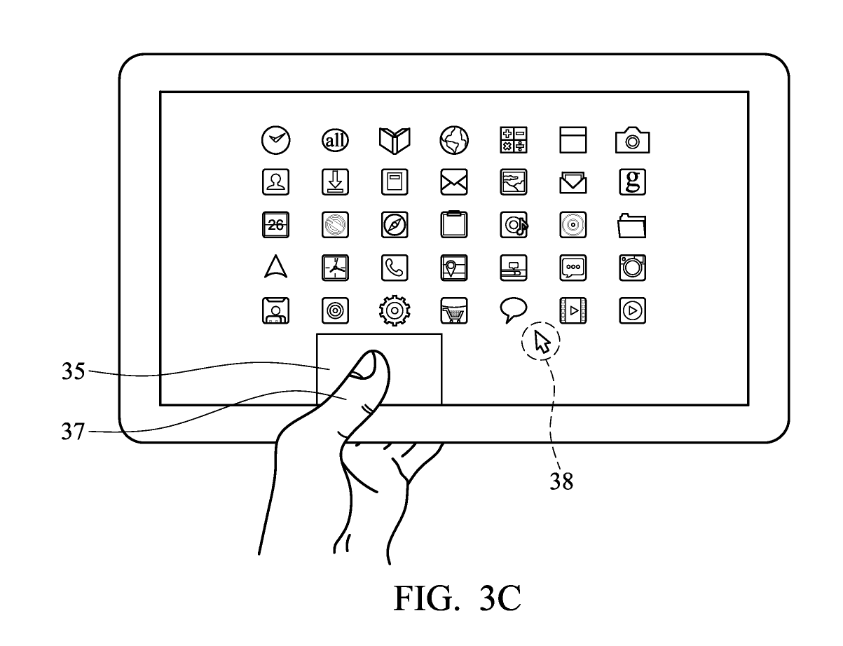

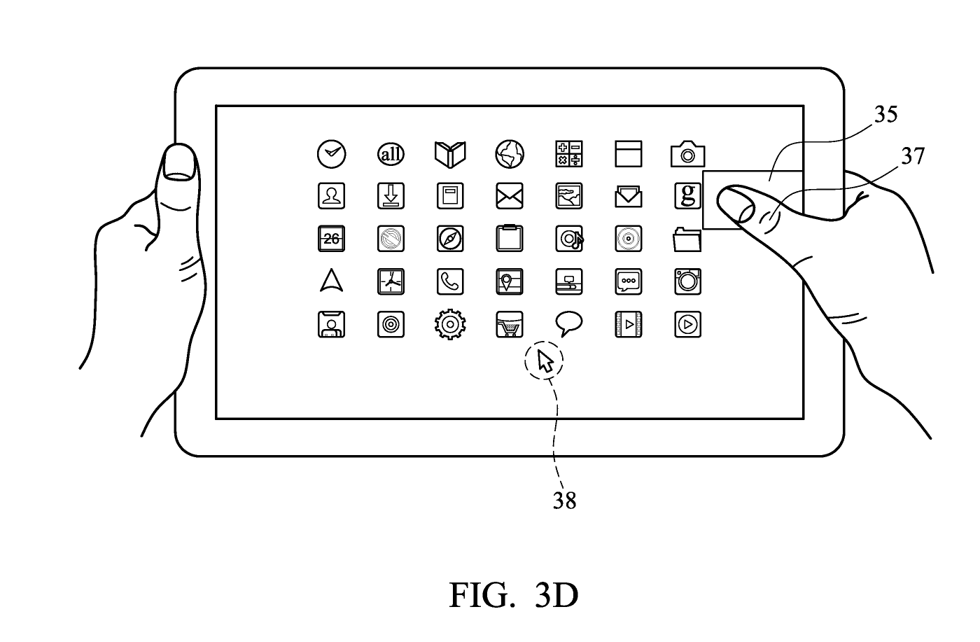

In step S201, when detecting a user contact on a margin part of the touch panel, a virtual touchpad is displayed at a first location within the margin part of the touch panel. Referring to FIG. 3A, a graphical user interface display is shown. As shown in FIG. 3A, when detecting a user contact on a margin part of the touch panel, a virtual touchpad 35 is displayed at a central part on the left-hand side margin part 33 of a display screen 30 on the touch panel. It should be apparent that the invention is not limited to this example, and the margin part 33 and the virtual touchpad 35 can be displayed in any design. For example, the margin part 33 and the virtual touchpad 35 can be displayed as a translucent area with a different color or a different grade of transparency. The margin part 33 can also be designed to be invisible to the user. The first location, i.e., the initial location of the virtual touchpad 35, can be any location within the margin part 33.

The margin part 33 marks an area in which the virtual touchpad 35 can be located. Accordingly, the user can designate any location in the margin part 33 for the virtual touchpad 35 (the process for designation is described later). The virtual touchpad 35 is used for receiving user operation for moving a cursor or other element around the touch panel, and for single-clicking or double-clicking. The margin part 33 and virtual touchpad 35 shown in FIG. 3A are described as an example. The arrangement and size of the margin part 33 and virtual touchpad 35 can be designed to meet requirements.

FIG. 3B illustrates an enlarged figure of virtual touchpad 35 shown in FIG. 3A. Two functional buttons, i.e., set button 351 and close button 353, are presented at the upper right corner of the virtual touchpad 35. When the set button 351 is activated, a setting section is initiated. During the setting section, features (such as location, color, and grade of transparency) of the virtual touchpad 35 can be set. When the close button 353 is activated during the setting section, the setting section ends and an operation section starts. In the operation section, the virtual touchpad 35 receives user operation. When the close button 353 is activated during the operation section, the operation section ends and the virtual touchpad 35 is not presented on the touch panel.

In step S203, when the set button 351 is activated and a setting section is initiated.

In step S205, the virtual touchpad 35 is dragged and dropped, by a real object such as a fingertip, from the first location to a second location, and the virtual touchpad 35 is moved and displayed at the second location. The second location can be any location within the margin part 33. For example, the virtual touchpad 35 is moved from the first location (as shown in FIG. 3A, the central part on the left-hand side margin part 33) to another location (the second location). For example, as shown in FIG. 3C, the virtual touchpad 35 can be presented at a lower side of margin part 33 (not shown in FIG. 3C); as shown in FIG. 3D, the virtual touchpad 35 can be presented at the right-hand side of margin part 33 (not shown in FIG. 3C).

The second location is designated by the user.

For example, when a user holds the portable electronic device with one hand and uses the other hand to handle the device, the second location can be set at the location shown in FIG. 3C. In this situation, the user can use his thumb 37 to contact the virtual touchpad 35 and perform operations to the cursor 38. For example, the user can make a single-click or double-click on the virtual touchpad 35.

When a user holds the portable electronic device with both hands, and manipulates the portable electronic device while holding it, the second location can be set at the location shown in FIG. 3D. In this situation, the user can use his thumb 37 to contact the virtual touchpad 35 and perform operations to the cursor 38. For example, the user can make a single-click or double-click on the virtual touchpad 35.

In step S207, when the close button 353 is activated during the setting section, the setting section ends and an operation section starts on the virtual touchpad 35.

In step S209, during the operation section of the virtual touchpad 35, operations such as cursor moving or mouse clicking are performed in response to contact gestures on the virtual touchpad 35.

In step S210, when the close button 353 is activated during the operation section, the operation section ends and the virtual touchpad 35 is not presented on the touch panel. The margin part 33 is not presented on the touch panel, either.

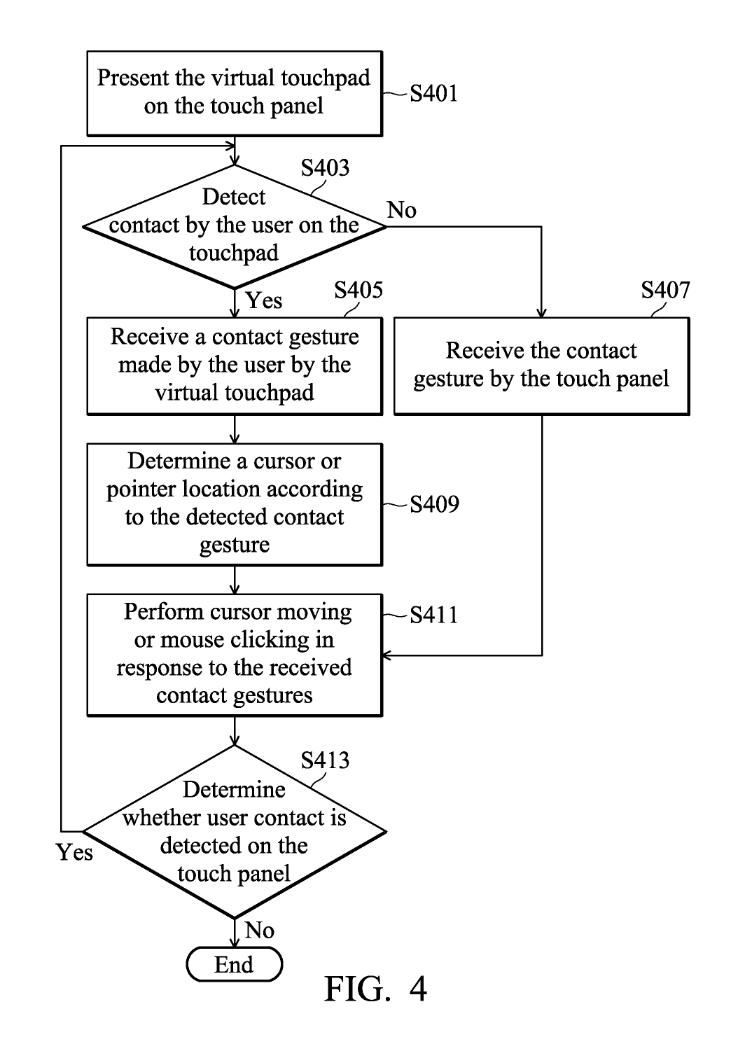

FIG. 4 is a flowchart illustrating the method for manipulating a virtual touchpad according to an embodiment of the invention. The method shown in FIG. 4 illustrates details of the operations performed in the operation section (as shown in step S209 of FIG. 2).

In step S401, the virtual touchpad is presented on the touch panel 35. By default, the virtual touchpad 35 is transparent and appears at the lower-side margin of the screen. It should be noted that a user can move the virtual touchpad 35 anywhere on the screen by dragging it. The virtual touchpad 35 is presented on top of the screen.

In step S403, contact by the user is detected on the touchpad, and the method proceeds to step S405. In step S405, a contact gesture made by the user is detected and received by the virtual touchpad 35. When the contact gesture is detected on a location other than the virtual touchpad 35, the method proceeds to step S407. In step S407, the contact gesture is received by the touch panel.

In step S409, a cursor or pointer location is determined according to the contact gesture detected in step S405.

In step S411, operations such as cursor moving or mouse clicking are performed in response to the contact gestures detected and received in step S405 or step S407.

In step S413, it is determined whether user contact is detected on the touch panel, and if so, the method returns to step S403, otherwise the method ends.

In the foregoing description, for explanation purposes, reference to specific embodiments has been made. However, the descriptions above are not intended to be exhaustive or to limit the invention to the precise forms disclosed.

Methods of controlling an electronic device, and related operating systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for controlling a portable electronic device with a user interactive touch panel, comprising:
displaying a display screen on the touch panel and displaying a screen object on the display screen;
displaying a virtual touchpad at a first location on the display screen;
upon detecting the virtual touchpad is dragged and dropped, by a real object, from the first location to a second location, moving and displaying the virtual touchpad at the second location; and
upon detecting a contact gesture implemented by the real object on the display screen, moving and displaying the screen object according to the detected contact gesture.

2. The method for controlling a portable electronic device with a user interactive touch panel of claim 1, wherein the screen object is a screen cursor.

3. The method for controlling a portable electronic device with a user interactive touch panel of claim 1, wherein both the first location and the second location are located at the margin of the display screen.

4. The method for controlling a portable electronic device with a user interactive touch panel of claim 1, upon detecting a clicking operation, by the real object, on the screen object, selecting a particular item displayed on a location corresponding to the screen object.

5. The method for controlling a portable electronic device with a user interactive touch panel of claim 4, wherein the clicking operation is a single-clicking operation.

6. The method for controlling a portable electronic device with a user interactive touch panel of claim 4, wherein the clicking operation is a double-clicking operation.

7. The method for controlling a portable electronic device with a user interactive touch panel of claim 4, wherein the real object is a user's fingertip.

8. The method for controlling a portable electronic device with a user interactive touch panel of claim 1, upon detecting moving of the real object on the display screen, controlling the screen object to move in a direction and distance corresponding to direction and distance of the detected moving of the real object.

9. A portable electronic device, comprising:
a user interactive touch panel, for displaying a display screen and receiving touch inputs, displaying a screen object on the display screen, and displaying a virtual touchpad at a first location on the display screen; and
a control unit, when detecting the virtual touchpad is dragged and dropped, by a real object, from the first location to a second location, moving and displaying the virtual touchpad at the second location, when detecting a contact gesture implemented by the real object on the touch panel, moving and displaying the screen object according to the detected contact gesture.

10. The portable electronic device of claim 9, wherein the user interactive touch panel displays a screen cursor as the screen object.

11. The portable electronic device of claim 9, wherein both the first location and the second location are located at the margin of the display screen.

12. The portable electronic device of claim 9, wherein the control unit, when detecting a clicking operation, by the real object, on the screen object, selects a particular item displayed on a location corresponding to the screen object.

13. The portable electronic device of claim 9, wherein the clicking operation is a single-clicking operation.

14. The portable electronic device of claim 9, wherein the clicking operation is a double-clicking operation.

15. The portable electronic device of claim 12, wherein the real object is a user's fingertip.

16. The portable electronic device of claim 9, wherein the control unit, when detecting moving of the real object on the display screen, controls the screen object to move in a direction and distance corresponding to direction and distance of the detected moving of the real object.
